(19) United States
(12) Patent Application Publication
(10) Pub. No.: US 2023/0056071 A1
(43) Pub. Date: Feb. 23, 2023

(54) STATION FOR ELECTRIC HAIR CUTTING DEVICES

(71) Applicant: Jose L. Suarez, Tampa, FL (US)

(72) Inventor: Jose L. Suarez, Tampa, FL (US)

(21) Appl. No.: 17/406,590

(22) Filed: Aug. 19, 2021

(51) Int. Cl. B26B 19/38; H02J 7/00

(52) U.S. Cl. CPC B26B 19/3873; H02J 7/0013; H02J 7/0044

(57) ABSTRACT

A station for maintaining and electrically charging electric hair cutting devices has a housing with first and second sections and an internal space within the housing below the sections. The first section has multiple electrical charging docks which are affixed to that section, each of the charging docks being dedicated and configured to electrically charge a specific manufacturer's electric hair cutting device. The second section has multiple through openings, each of the through openings being configured to accept and circumscribe, a separable, removeable, independent charging dock of a manufacturer's electric hair cutting device. The internal space of the housing contains one or more electrical power strips with electrical wires which exit the housing and are configured to be connected to an electrical power source for supplying electricity to the charging docks.

### FIELD OF THE INVENTION

The present invention relates to a dedicated station for maintaining and charging electric barber and hair cutting devices, particularly electric shavers and electric hair clippers and trimmers.

### BACKGROUND OF THE INVENTION

Charging docks designed to electrically charge shavers, trimmers, clippers, and like electric devices are well known. These docks typically comprise a base having a cradle to support the device in a substantially upright position, so that it can make electrical contact with an electrical power source, to thereby charge the device's batteries. Docking stations are also utilized as stands for storing and maintaining the electric devices when they are not in use.

Electrical charging docks which maintain the electric devices also provide easy access for the professional user who repeatedly places the devices down during the shaving or hair cutting process. For instance, while cutting a section of an individual's hair, the user may be required to comb or otherwise reposition the hair. In such cases, the user is required to set the device down, but then be able to easily retrieve it when needed again. This could present a problem when the device cannot be quickly located.

In fact, professional barbers and hair stylists usually have many shaving and hair cutting devices which they routinely use for a given customer. The devices are often placed on a flat table or counter when they are not being used. This presents another problem, in attempting to maintain an organized work area for the professional when there are multiple devices in play. Electric devices, once they are set down, can become separated from their charging docks, resulting in confusion when trying to replace the devices on their proper charging docks and when attempting to retrieve a specific device.

There is currently no dedicated station for maintaining electric devices, like shavers, hair trimmers and clippers, in an organized fashion, for ease of locating a particular device, especially when the professional is actively attending to a customer.

### SUMMARY OF THE INVENTION

It is thus the object of the present invention to provide a station for electric hair cutting devices like shavers, hair clippers, and hair trimmers which not only maintains these electric devices in an organized fashion, but also contemporaneously serves to electrically charge them as well.

These and other objects of the present invention are accomplished by a station for maintaining and electrically charging electric hair cutting devices, such as electric shavers, hair clippers, and hair trimmers. The station has a housing with first and second sections and an internal space within the housing below the sections. The first section has multiple electrical charging docks which are affixed to that section, each of the charging docks being dedicated and configured to electrically charge a specific manufacturer's electric hair cutting device. The second section has multiple through openings, each of the through openings being configured to accept and circumscribe, a separable, independent charging dock of a manufacturer's electric hair cutting device. The internal space of the housing contains one or more electrical power strips with electrical wires which exit the housing and which are configured to be connected to an electrical power source for supplying electricity to the charging docks.

The novel features which are considered as characteristic of the invention are set forth in particular in the appended claims. The invention itself, however, both as to its design, construction, and use, together with additional features and advantages thereof, are best understood upon review of the following detailed description with reference to the accompanying drawings.

### BRIEF DESCRIPTION OF THE DRAWINGS

FIG. 1 is a perspective front view of the station of the present invention.

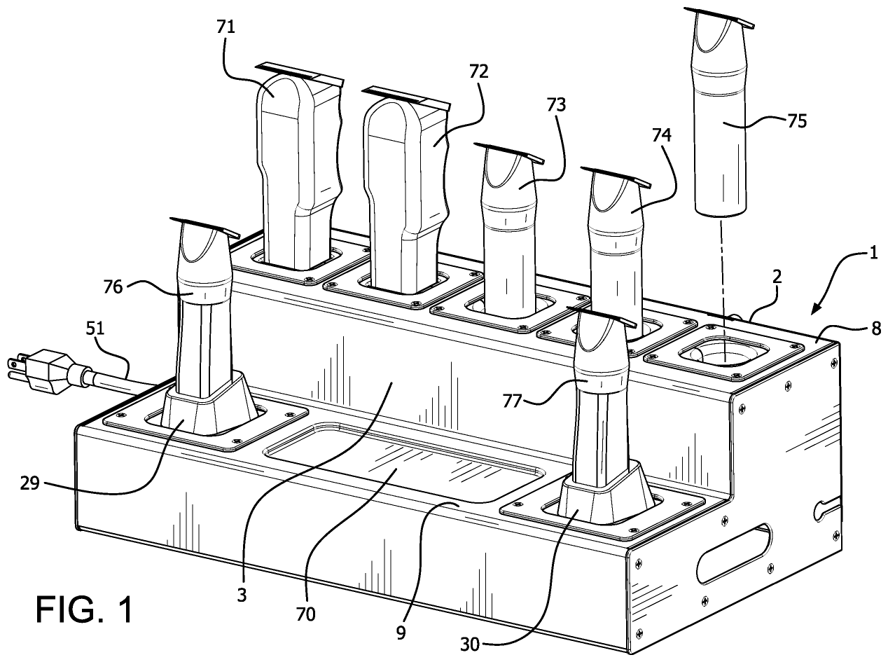

FIG. 2 is an exploded view of components of the present invention and the placement of hair cutting devices on the station.

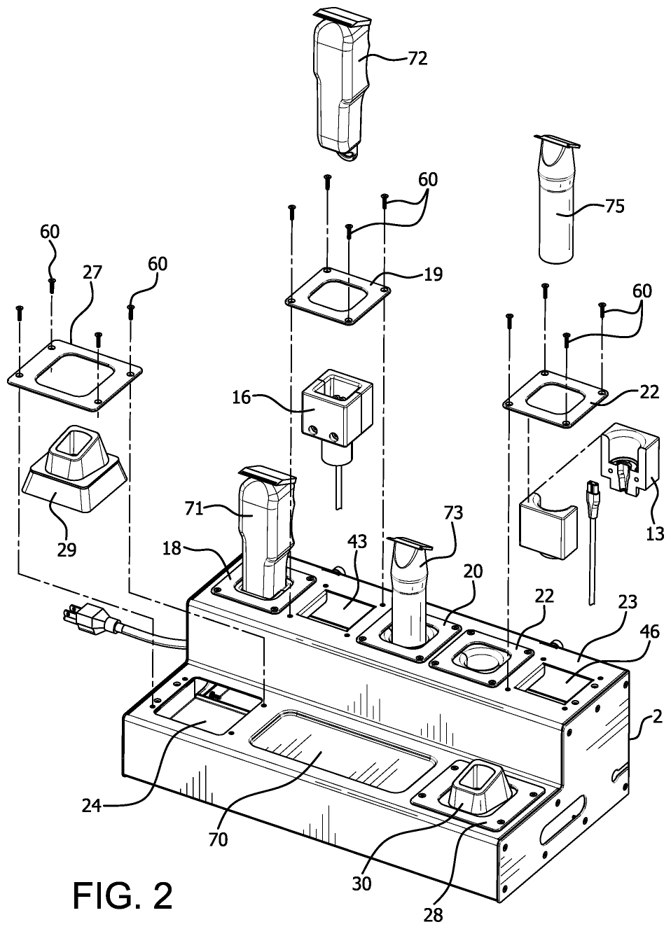

FIG. 3 is a rear, partially exploded perspective view of the present invention.

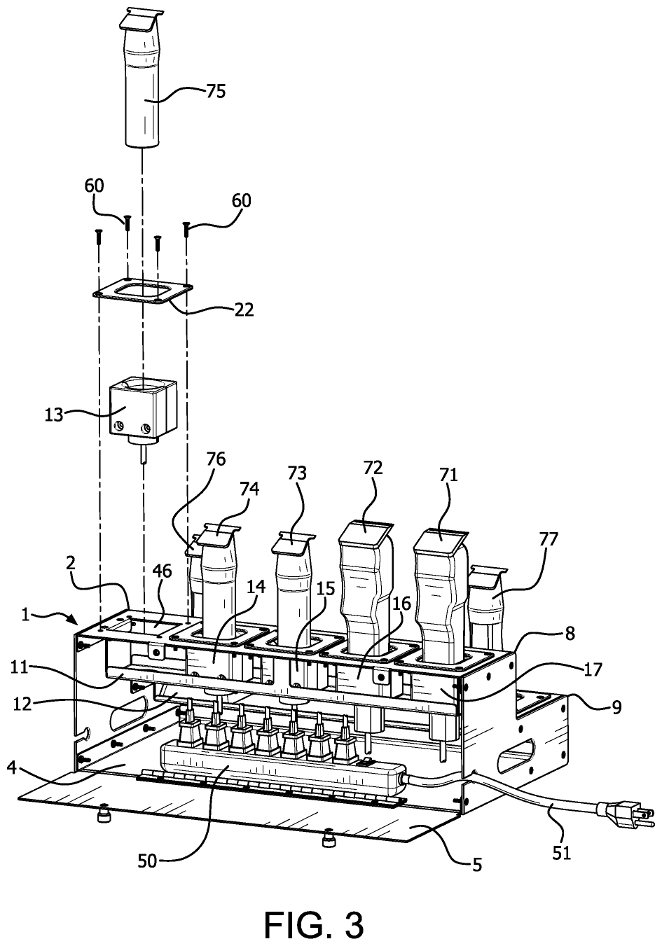

FIG. 4 is a rear view of the present invention.

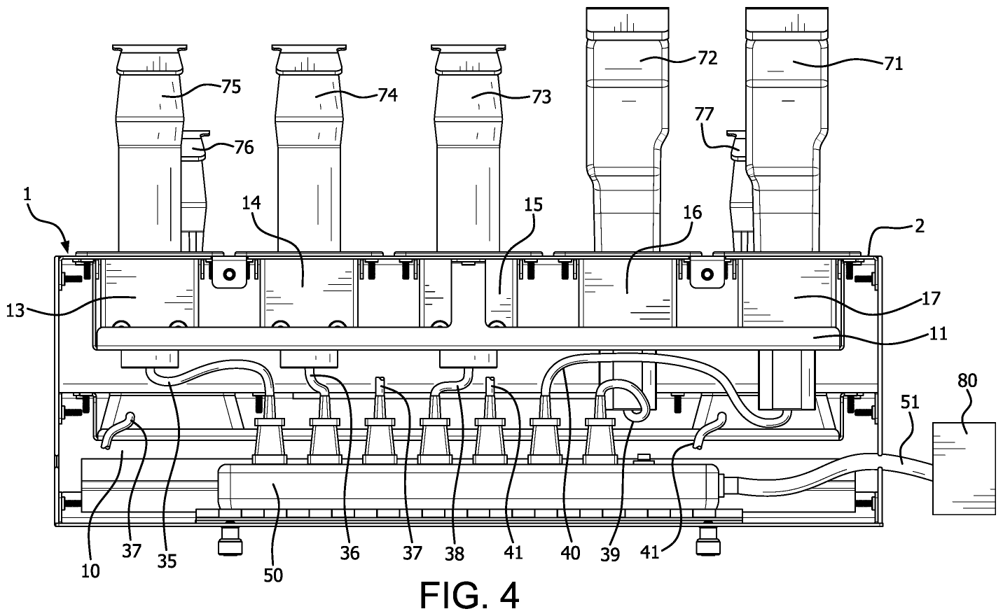

FIG. 5 is an exploded view of the components of the housing of the present invention.

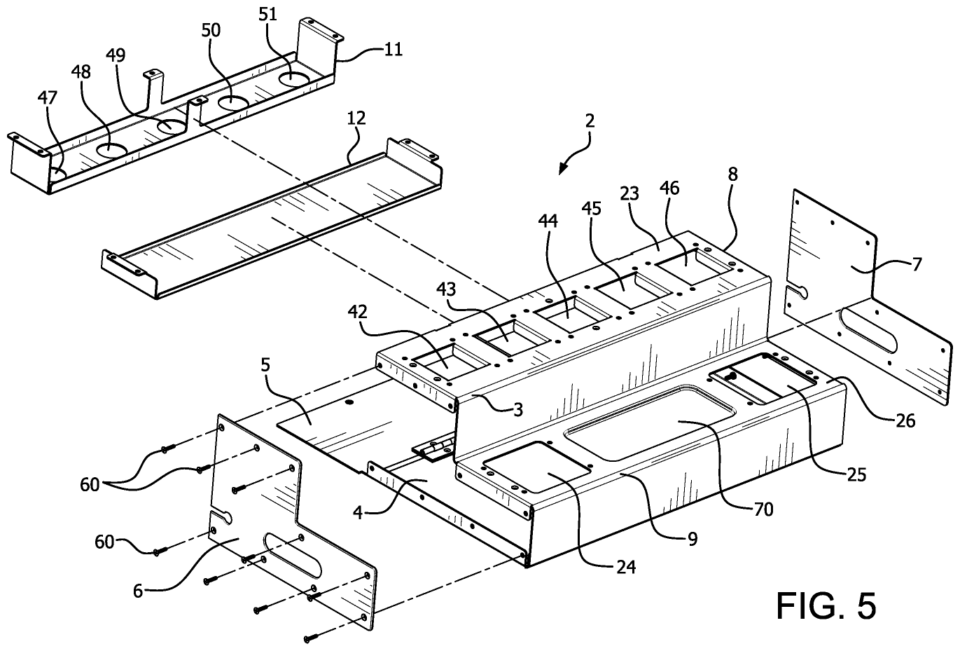

### DETAILED DESCRIPTION OF THE INVENTION

Station 1 of the present invention comprises housing 2 which comprises main body section 3, floor member 4, hinged back panel 5, and side panels 6 and 7. These components are secured together by screws 60 to form housing 2, made up of first section 8 located at a level above second section 9. Housing 2 encloses internal space 10, encompassed by sections 8 and 9 and floor member 4. Charging dock support trays 11 and 12 are secured within internal space 10 also by means of screws 60.

First section 8 has electrical charging docks 13, 14, 15, 16, and 17 which are permanently affixed to housing 2 by means of screws 60 through attachment plates 18, 19, 20, 21, and 22, into top surface 23 of first section 8. These charging docks are positioned within openings 42, 43, 44, 45, and 46 and they extend down through holes 47, 48, 49, 50, and 51 of support tray 11 and into internal space 10. Each charging dock 13, 14, 15, 16, and 17 is dedicated and configured to electrically charge electric devices of specific different manufacturers, i.e. electric shavers, clippers, and/or hair trimmers 71, 72, 73, 74, and 75.

Second section 9 has openings 24 and 25 through its top surface 26. A rubber or equivalent material resting pad 70 is located on top surface 26. Top surface reinforcement plates 27 and 28 are attached by screws 60 to top surface 26. These plates surround openings 24 and 25, which are configured to accept and circumscribe separable, independently positioned charging docks 29 and 30, dedicated and configured to electrically charge electric devices of specific manufacturers, i.e. electric shavers, trimmers, and/or clippers 76 and 77. Charging docks 29 and 30 are not attached to section 9, as opposed to charging docks 13, 14, 15, and 17 which are permanently affixed to section 8. Instead, charging docks 29 and 30 extend through openings 24 and 25 and rest on dock support tray 12 in housing 2.

Electrical wiring 35, 36, 37, 38, 39, 40, and 41 is connected to and extends from charging docks 13, 14, 15, 16, 17, 29, and 30; and this wiring is ultimately connected via electrical plugs to power strip 50 located within internal space 10. Electric wire 51 extends from power strip 50 and exits housing 2, where it is connected to electrical power source 80 for supplying electricity to each of the charging docks.

In this manner, all electric hair trimming devices can continually be charged, and still be located in their specific, designated charging docks, within easily available locations for use.

It is contemplated that this invention should not to be restricted to the number of sections which make up the housing of the station, the position of each section in relation to each other, the number of permanently affixed electrical charging docks, or the number of openings for the positioning of the independent electrical charging docks. The sections of the station can be arranged in alternate spaced relations to each other, but the herein disclosure contemplates maximum convenience and ease of use. Similarly, it should be understood that any number of charging docks can be utilized for any number of electric devices, whether these electrical devices are charged by means of the affixed charging docks or independently positioned charging docks.

In fact, certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A station for maintaining and electrically charging electric hair cutting devices such as electric shavers, hair clippers, and trimmers, said station comprising:
a housing comprising first and second sections and an internal space within the housing, the first section having multiple through openings and multiple electrical charging docks extending through the openings and affixed to said section, each charging dock dedicated and configured to electrically charge a specific manufacturer's electric hair cutting device, the second section having a resting pad on a top surface of the second section and multiple openings through the top surface, each of the through openings being configured to accept and circumscribe a separable, removeable, independent, charging dock which is not affixed to the second section, each charging dock being dedicated and configured to electrically charge a specific manufacturer's electric hair cutting device, and charging dock support trays located within the housing to support the charging docks in the first and second sections; wherein the internal space of the housing contains an electrical power strip having an electrical wire which exits the housing and is configured to be connected to an electrical power source for supplying electricity to each of the charging docks.

2. The station as in claim 1 wherein the charging docks affixed to the first section extend down into the internal space of the housing.

3. The station as in claim 2 wherein the first section is located on a level above the second section.

4. The station as in claim 1 wherein the first section is located on a level above the second section.

5. The station as in claim 1 wherein electrical wiring extends from each of the charging docks and is connected to the power strip.

6. The station as in claim 3 wherein electrical wiring extends from each of the charging docks and is connected to the power strip.
